(19) United States
(12) Patent Application Publication
(10) Pub. No.: US 2004/0089033 A1
(43) Pub. Date: May 13, 2004

(54) Door lock structure

(76) Inventor: Mei-Feng Lu, Taipei Hsien (TW)

Correspondence Address: SHOEMAKER AND MATTARE, LTD, P.O. BOX 2286, 2001 JEFFERSON DAVIS HIGHWAY, ARLINGTON, VA, 22202-0286, US

(21) Appl. No.: 10/692,787

(22) Filed: Oct. 27, 2003

Related U.S. Application Data
(60) Provisional application No. 60/436,648, filed on Dec. 30, 2002.

(30) Foreign Application Priority Data
Oct. 29, 1998 (TW) 87217902

(51) Int. Cl. E05B 59/00; E05B 63/14

(52) U.S. Cl. 70/107

(57) ABSTRACT

A door lock structure is proposed, including a chassis, a tongue mechanism, a latch mechanism, a security latch mechanism, a doorknob linking mechanism and a doorknob control mechanism, which is characterized in that a restriction member that restricts the relative motion between the linking member and the rotating member is installed between the rotating member connected with the doorknob and the linking member connected with the latch mechanism. The restriction member controls the doorknob to be linked or unlinked by means of a button, wherein an adjustment piece is formed at an edge of a transmission piece having a contact with the restriction member to adjust the doorknob to be located on inner side or outer side of the door. Also, a fireproof piece having a security function is disposed in the latch mechanism to prevent the door from opening in case of a fire hazard.

This application claims priority from U.S. application Ser. No. 60/436648, filed Dec. 30, 2002.

### FIELD OF THE INVENTION

The present invention relates to door lock structures, and more particularly, to a door lock with improvements in a door knob linking mechanism that links a doorknob to a lock latch, and to a doorknob control mechanism which controls the link between the doorknob and the lock latch, so as to simplify a linking architecture for the door lock, to reduce the malfunction rate of the linking and control mechanisms, and to ease the installation and configuration procedure of the door lock.

### BACKGROUND OF THE INVENTION

Common door lock comprises a lock tongue mechanism which can be opened using a key, and a lock latch mechanism coupled to a doorknob or a handle to allow door opening by rotating the doorknob or by pulling the handle. The doorknob or the handle is usually disposed inside the door (facing the room) for enabling a user in the room to exit and for preventing undesired trespassing. However, if the user needs to enter and exit frequently in a short period of time, he/she is then required to bring a key to open the door at a high frequency. Therefore, some door locks provide a doorknob or a handle outside the door (facing outdoor) and a button or a control device on each of the door locks to allow opening from both inside and outside of the room, or from only inside of the room. For example, the Yale lock commonly designed for indoor use comprises a push button at center of the doorknob. When the button is depressed, the door cannot be opened from outside of the room. When the doorknob is rotated from inside, the button is automatically retracted to release locking of the doorknob outside.

FIG. 1 and FIG. 2 show a conventional door lock structure. A push rod 210′ of a rotating member 21′ is pushed downwards to cause pivoting of the rotating member 21′. As illustrated in FIGS. 3A and 3B, the screw C of the rotating member 21′ slides in the trench 230B′ of the engage plate 23B′ to cause the engage plate 23B′ to move to the right in the drawing. The movable plate 33B′ approaches to the movable plate 33A′ along a slanted face of the slanted part 233B′ due to the suppression from the movement of the engage plate 23B′ and arrives to a fixed location leaning against the engage plate 32B′. Therefore, the originally unengaged outside doorknob can pivot with the drive shaft 31B′ connected therewith, such that the movable plate 33B′ is driven to swing by the engage plate 32B′ that links to the drive shaft 31B′, so as to push the main lock mount 40′ in order for the lock latch 401′ to retract into the chassis 1′.

Furthermore, since the locking device may be installed either on the left side or the right side of a door leaf, the screw C of the locking device can be screwed into the rotating member 21′ from either the trench 230B′ or 230A′. As illustrated in FIG. 3A through to FIG. 3C, the door lock can be installed in both directions.

Although the aforementioned locking device can control the doorknob outside and can be installed in both directions, it possesses the following disadvantages: The locking device has a high malfunctioning rate. There is a complex linking architecture for components, such as the rotating member 21′, the engage plates 23A′ and 23B′, the fixing shaft 24′ of the control mechanism 2′, the engage plates 32A′ and 32B′, the movable plates 33A′ and 33B′ of the doorknob mechanism 3′. And the rotating member 21′, the engage plates 23A′ and 23B′, the engage plates 32A′ and 32B′, and the movable plates 33A′ and 33B′ are parallel to the substrate 10′ of the body 1′. So, some components and joints might be shaken to dislocate due to vibration as a result of opening/closing the door when the locking device is vertically installed on the door leaf. For example, the screw C may dislocate from the trench 230B′ or 230A′ or engage plates 33A′ and 33B′ may dislocate from the movable plates 32A′ and 32B′ due to vibration of the door. This invalidates the control function of the rotating member 21′ over the doorknob outside.

It is not easy to perform installation and adjustments for the locking device. A linking architecture between the control mechanism 2′ and the doorknob mechanism 3′ is complex. For example, the installation for the sliding trench 232A′ and 232B′ of the engage plates 23A′ and 23B′, the movable plates 33A′ and 33B′ that are close to the axle 35′, and the compression spring 36′ in a space between the plates is not easy. Furthermore, it is also not easy to execute adjustment actions, including tearing apart the above-mentioned linking architecture which is not easily installed, unscrewing of the screw C, and screwing of the rotating member 21′ for bi-directional installation.

There is no fireproof feature for the locking device. The locking device cannot isolate fire and flames during a fire to comply with the required public safety level.

### SUMMARY OF THE INVENTION

Therefore, an objective of the present invention is to provide an improved door lock structure with a simple linking architecture for the doorknob linking mechanism and the doorknob controlling mechanism to lower manufacturing cost and the rate of malfunctioning.

Another objective of the present invention is to provide an improved door lock structure where the installation of the linkage mechanism and the doorknob mechanism are simple and the adjustment of the dual direction installation is stepwise simple for reducing the installation time.

Another objective of the present invention is to provide an improved door lock structure having a simple fireproof structure for preventing opening of the door leaf during a fire to abide with fireproof regulations.

In order to accomplish the aforementioned and other objectives, the present invention provides an improved door lock structure comprising a chassis, a tongue mechanism, a latch mechanism, a security latch mechanism, a doorknob linking mechanism and a doorknob control mechanism. The doorknob linking mechanism comprises a rotating member pivoted in the chassis and a linking member pivoted on the rotating member, wherein the linking member having an arm that contacts the latch mechanism and the linking member pivots with a through hole thereon on a protruding shaft of the rotating element. The rotating members further connect with each other by pivoting the protruding shaft in a hole on the chassis or other non-disengaging and easy installing manners. Two sets of symmetrically stacked rotating member and linking member are disposed in between two opposite chassis walls of the chassis. The doorknob connects with the protruding shaft pivoted in the chassis. The doorknob has an engaging part with a non-circular cross-sectional surface (e.g. star-shape, square-shaped, etc.) to fit on the engaging hole of the protruding shaft with the same cross-sectional surface as that of the engaging part, so that the rotating member is rotated while rotating the doorknob.

The relative movement between rotating member and linking member described above is controlled by the doorknob control mechanism. When there is a relative movement between the rotating member and the linking member, the doorknob is turned without moving the rotating member. When there is no relative movement between the rotating member and the linking member, the doorknob is turned to move the linking member and to link the lock latch mechanism with the arm that contacts with the lock latch mechanism. The doorknob control mechanism comprises a restriction member that restricts the relative movement between the linking mechanism and the rotating member, a button pivoted on the chassis, and a pair of transmission pieces that contact the button, wherein one of the transmission piece releases the restriction of the linking member from the restriction member by pressing the button.

The restriction member is pivoted on the linking member. One end of the restriction member forms a passive portion contacting with the rotating member. The passive portion projects towards the rotating member and penetrates the rotating member to form a groove or a crack at the rim of the rotating member. Therefore, when the doorknob is turned to rotate the rotating member, the gap or crack acts on the passive portion to push the restriction member that comprises the passive portion. Since the restriction member is pivoted on the linking member, the linking member moves simultaneously together with the doorknob and the rotating member, and links the latch mechanism by the arm. By pushing the other end of the restriction mechanism, the restriction member may be rotated. The passive portion thus retracts from the gap or crack to outside the rotational range of the rotating member and releases the linkage between the rotating member and the linking member.

The button comprises two wings, wherein a pair of transmission pieces has one edge that contacts with an inner surface of the two wings, and the other edge of the transmission pieces is adjacent to the other end of the restriction member. As a result, the transmission pieces are formed to erect and slide between the opposite chassis walls of the chassis and are linked to the lever pivoted in the chassis, wherein the lever connects to the pair of transmission pieces by its two ends. When one wing of the button is pushed down, the wing shifts the transmission piece to push one end of the lever piece, making the lever piece to rotate. So, the other end of the lever piece drives the other transmission piece to slide towards the other wing of the raised button. When the other wing of the button is pushed down, the movement of each element acts exactly in a reverse order.

An adjustment piece that may be push in and out is mounted on an edge of the other end of the transmission piece close to the restriction member as described above. The adjustment piece is pre-adjusted to push an end of the transmission piece. While one wing of the button is pressed, the wing shifts the transmission piece to push the other end of the restriction member, and releases the linkage between the rotating member and the linking member. As described above, two sets of symmetrically rotating element and linking element are formed by stacking in between the two opposite chassis walls of the chassis. So, two adjustment pieces may also be mounted on the edge to approach the other end of the restriction member pivoted on the two linking members, respectively to fulfill requirements for bi-directional installation.

In addition, a fireproof piece may be pivoted on the latch mount that is connected to the lock latch formed to penetrate the chassis in the latch mechanism. The fireproof piece comprises a security pin made of a thermal-melting material. The security pin is inserted in the latch mount to prevent the fireproof piece from sliding down due to gravity. As a fire accident occurs, the fireproof piece will be locked between the latch mount and a protruding pillar fixed on the chassis while the lock latch retracts into the chassis, since the security pin is molten when heated. The door thus remains closed and the fire is stopped outside the door.

### BRIEF DESCRIPTION OF THE DRAWINGS

The present invention can be more fully understood by reading the following detailed description of the preferred embodiments, with reference made to the accompanying drawings wherein:

FIG. 1 (PRIOR ART) is a perspective view of the internal structure of a conventional door lock;

FIG. 2 (PRIOR ART) is a partial plan view of the aforementioned conventional door lock, wherein the doorknob mechanism and the doorknob control mechanism are illustrated;

FIGS. 3A, 3B and 3C (PRIOR ART) are cross-sectional views illustrating action of turning the rotating member of doorknob control of the conventional door lock;

FIG. 4 is a perspective view illustrating an internal structure of the door lock according to the present invention;

FIG. 5 is an exploded view illustrating the door lock according to the present invention;

FIG. 6 is a plan view of the door lock according to the present invention, wherein a lock tongue mechanism, a lock latch mechanism, a security mechanism, a doorknob linking mechanism, and a doorknob control mechanism are illustrated;

FIG. 7 is a plan view of the door lock according to the present invention, wherein the doorknob linking mechanism is linked to the lock latch mechanism for retracting the lock latch into the chassis;

FIG. 8 is a plan view of the door lock according to the present invention, wherein the restricting rod drives the lock tongue mechanism for retracting the lock tongue into the chassis, and the doorknob control mechanism releases restriction of the restriction member on the linking member, so that the linking member is not linked by the rotating member;

FIG. 9 is a schematic view of another opposite push of the linking member and the rotating member formed by stacking at the bottom layer according to FIG. 8, wherein the restriction member mounted between the linking member and the rotating member are illustrated;

FIGS. 10A and 10B are top and bottom views of the transmission piece mounted with adjustment pieces according to FIG. 8;

FIG. 11 is a partial plan view of the door lock according to the present invention, illustrating security pin mechanism without corresponding pin hole and actions for the security pin member and swing piece of the security pin mechanism when the door leaf is closed; and

FIG. 12 is a plan view of the door lock according to the present invention, illustrating a braking rod is turned to move the linking member, which in turns links to the lock latch mechanism for retracting the lock latch into the chassis when the key is turned twice.

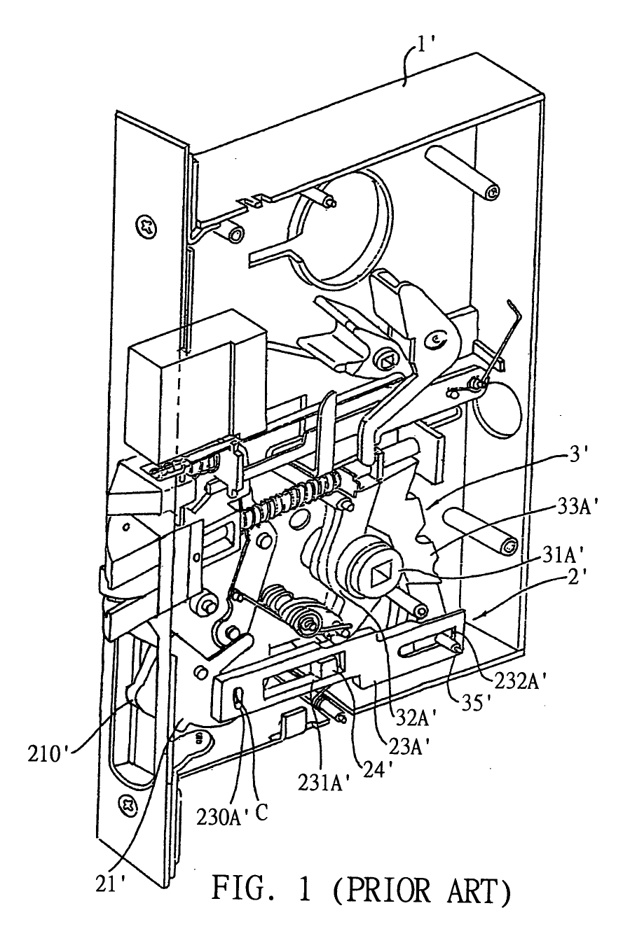

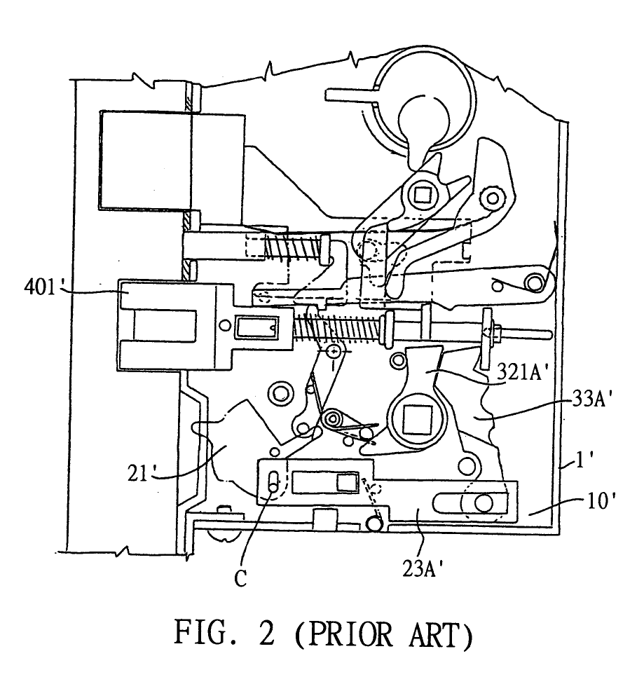

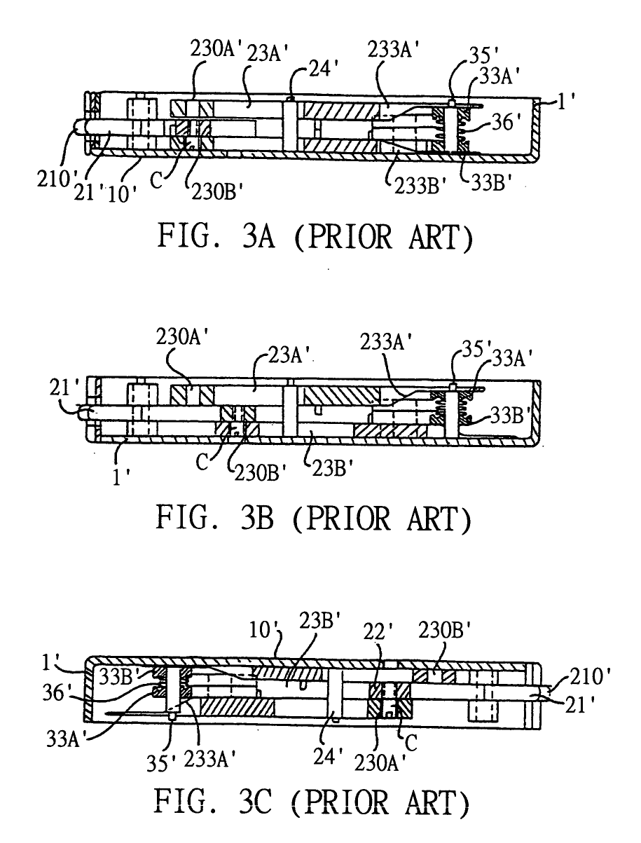

### DETAILED DESCRIPTION OF THE PREFERRED EMBODIMENTS

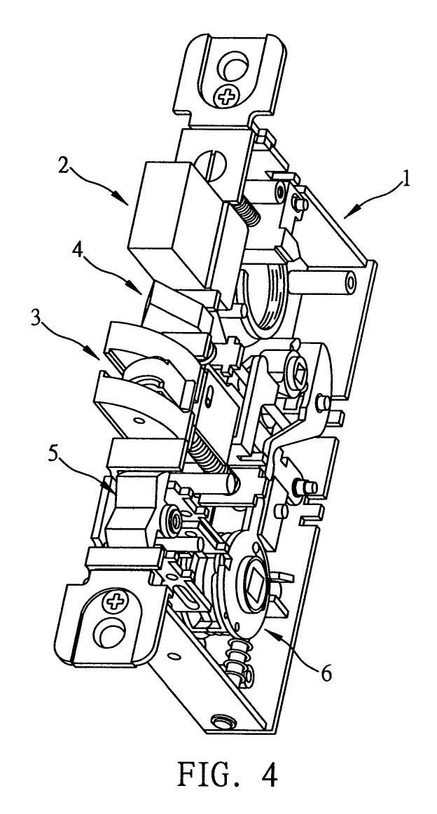

As illustrated in FIG. 4, a door lock of the present invention comprises a chassis 1, a tongue mechanism 2, a latch mechanism 3, a security latch mechanism 4, a doorknob linking mechanism 5, and a doorknob control mechanism 6.

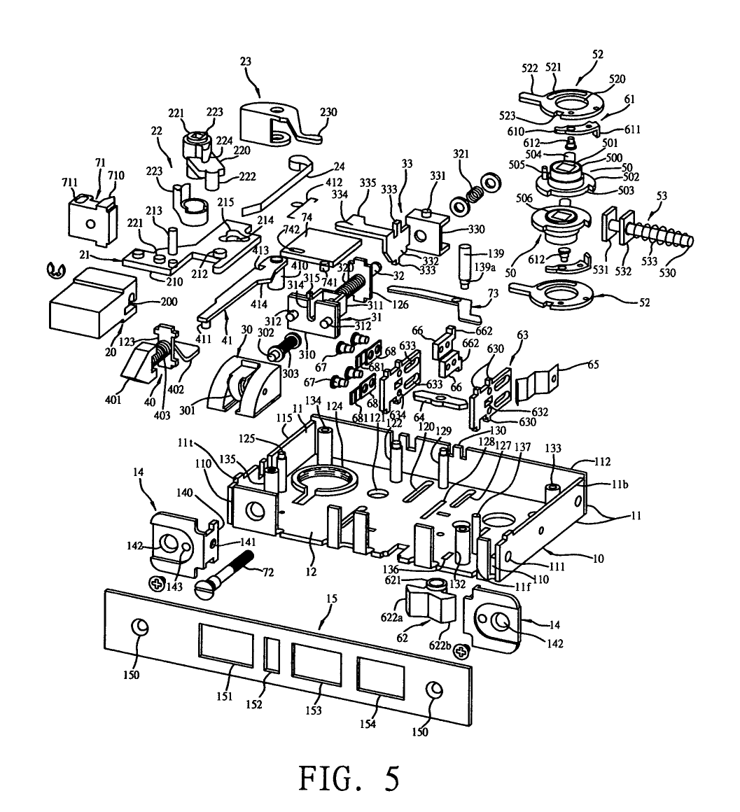

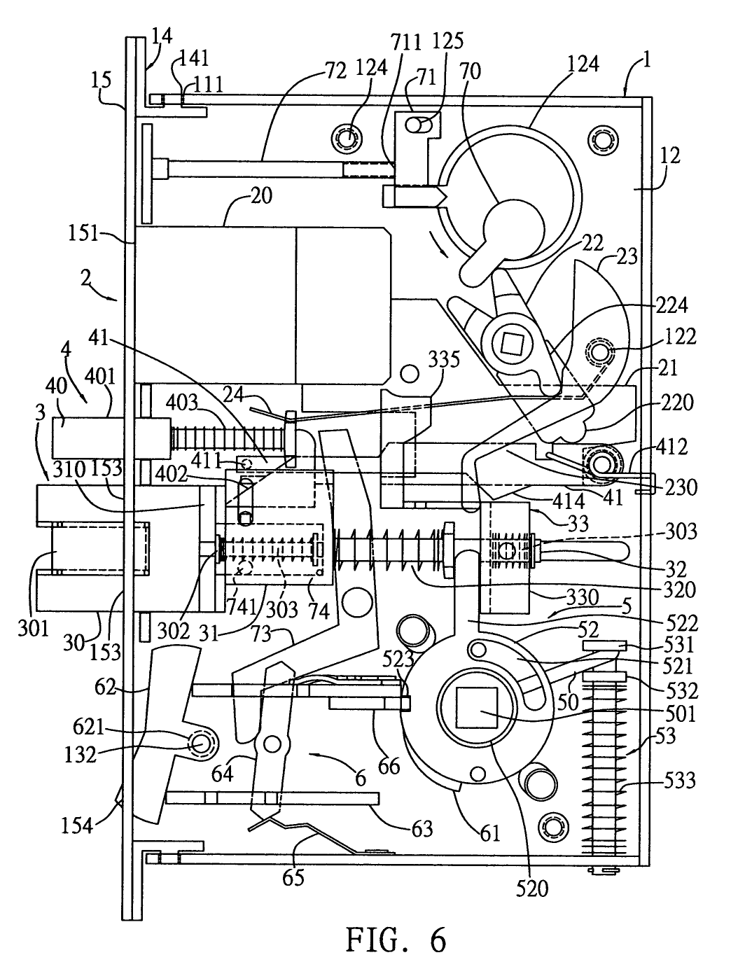

As illustrated in FIG. 5, the chassis 1 is comprised of a frame 10 and a cover (not shown) overlaying the frame 10. Separating walls 11 around the frame 10 and slits and holes on a substrate 12 can be formed by directly punching and pressing a metal plate. Two ear-shaped pieces 14 are mounted to the frame 10 by inserting base parts 140 of the ear-shaped pieces 14 into gaps 110 between a front separator 11f and both the top and bottom separators 11t and 11b. Each ear-shaped piece 14 is connected to the hole 111 of the top and bottom separators 11t and 11b by a projecting dot 141 formed on the base part 140 of the ear-shaped piece 14. As shown in FIG. 5 and FIG. 6, when the chassis 1 is mounted in an installation hole (not shown) on one side of a door, the ear-shaped piece 14 is firmly secured to the side of the door. By fine tuning the position of ear shape piece 14 relative to that of the chassis 1, the ear-shaped piece 14 is fitted to the side of the door and fastened to the door by screws that penetrate the holes 142.

A panel 15 is secured on the ear shape piece 14 by screwing the screws in the hole 150 on the panel 15 and the thread hole 143 on the ear shape piece 14 for the purpose of covering the inner parts of the chassis 1 and creating a flat surface for the door lock. The panel 15 has a tongue opening 151, a security latch opening 152, a latch opening 153, and a button opening 154, which openings correspond to the slits on the front separator 11f, as shown in FIG. 5.

The tongue mechanism 2is installed in the chassis 1 as shown in FIG. 6. The tongue mechanism 2 comprises a lock tongue 20 formed to penetrate through the tongue opening 151, a slide base 21 connected with the lock tongue 20, a driving member 22 that is pivoted on the chassis 1 and has one outward extending end 220 pivoted to the slider 21, and a linking member 23 pivoted on the chassis 1. As shown in FIG. 5, the slide base 21 is connected with the lock tongue 20 by inserting the engaging part 210 having a projecting dot 211 thereon into the slot 200 at the rear of the lock tongue 20. The slide base 21 slides on the surface of the substrate 12 with the sliding pillar 212 affixed on the lower surface of the slide base 21. The sliding pillars 213 and 214 are formed to slide in the corresponding trenches 120 in the substrate 12 and the cover, so as to maintain the lock tongue 20 moving linearly between the front and back separating plates 11f and 11r.

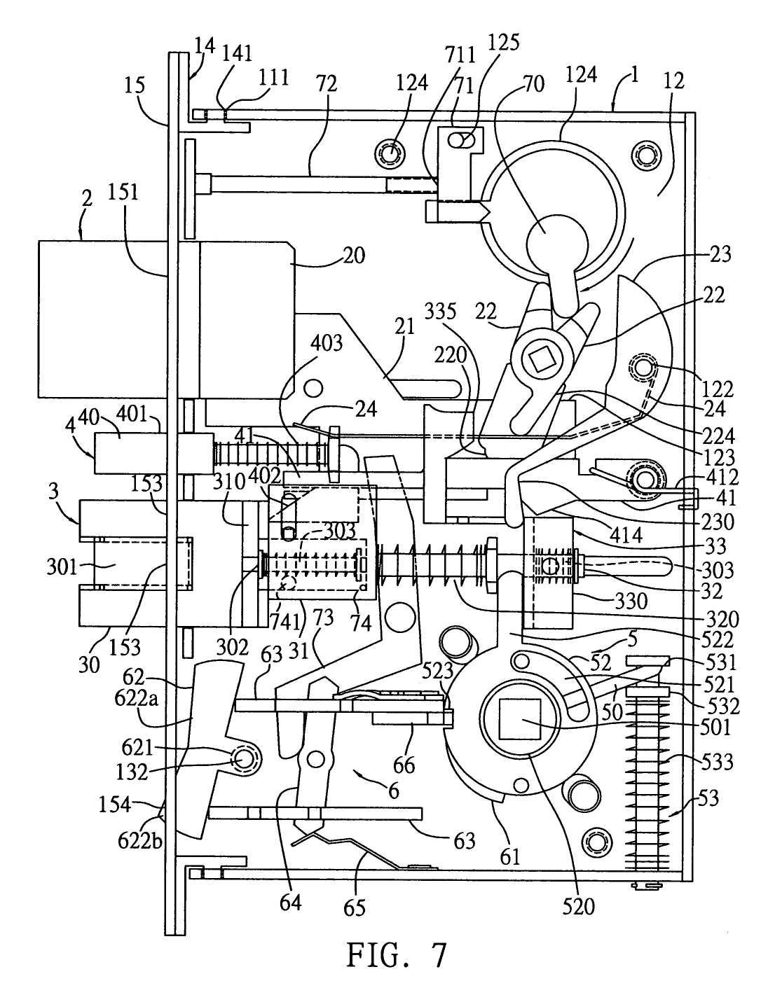

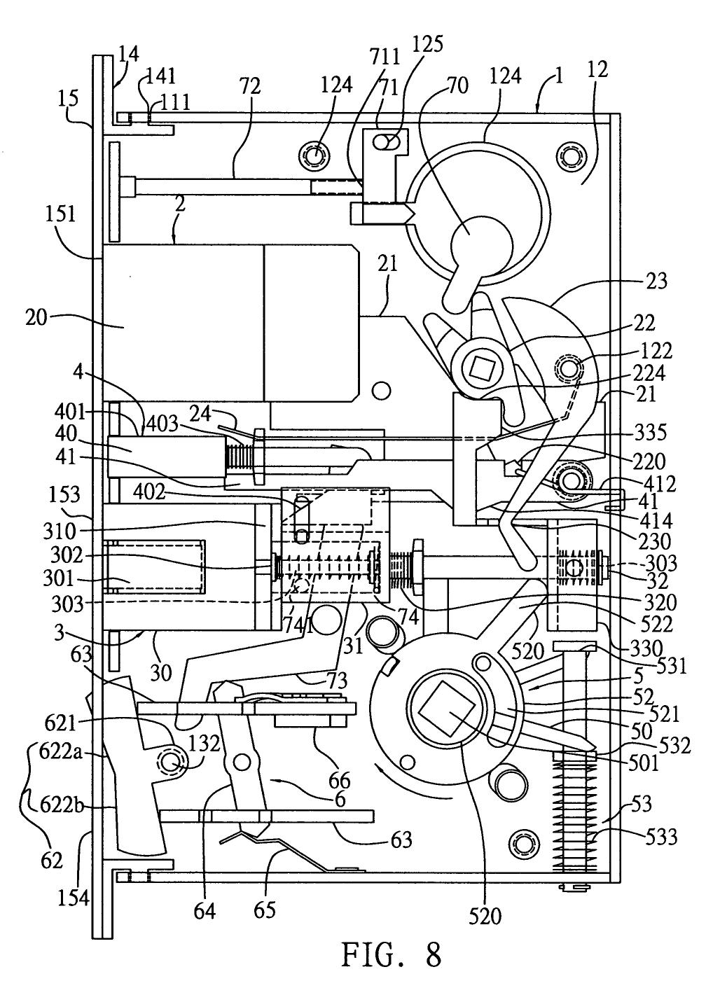

As illustrated in FIG. 5, the driving member 22 is pivoted with bearings formed on upper and lower ends thereof in the corresponding holes 121 in the cover and the substrate 12. One end 220 of the driving member 22 has a protruding pillar 222 pivoted to a groove 215 at the back end of the slide base 21. The trench 215 is roughly in a triangular shape, such that the driving member 22 pivoted to the chassis 1 can drive slide base 21 to move linearly. The other end 223 of the driving member 22 is divided into two parts which provide a lock core (not shown) with an actuator rod 70 for the driving member 22 to act in a clockwise or counterclockwise direction. The driving member 22 is then driven to rotate, so that the slider 21 drives the lock tongue 20 to extend or to retract in the tongue opening 151, as illustrated in FIG. 7 and FIG. 8. The linking frame 23 is pivoted through the shaft 122 on the chassis 1 by means of the shaft hole on the upper and lower frame of the linking frame 23. One end of the upper frame extends out to form a linking arm 230. An elastic piece 24 with a curled end is formed in the part of the shaft 122 between the upper and lower frames of the linking frame 23. A front end of the elastic piece 24 extends out to contact with a side edge of a corner board 123 disposed between the cover and the substrate 12. The middle section of the elastic piece 24 contacts the sliding portion 224 of the driving member 22. With the force generated as a result of opening the lock core with a key, the actuator rod 70 is turned to move the driving member 22, which then drives the lock tongue 20 to extend from or retract into the tongue opening 151 for generating the feeling of locking or unlocking the lock.

Referring to FIG. 5 or FIG. 6, a big circular hole 124 with a long side trench is formed on the substrate 12. There is also a corresponding big circular hole on the cover that is not shown. The aforementioned lock core is placed in the big circular hole 124 and tightened by the sliding piece 71 that is formed to slide in the chassis 1. The sliding piece 71 linearly slides along the long trench portion of the big circular hole 124 by the sliding track 710 having a tightening point at the upper and lower ends of the sliding piece 71. The guiding pillar 125 of the substrate 12 is sleeved by the sliding trench 711 at one side of the sliding piece 71 to restrict a sliding journey of the sliding piece 71. An adjustment screw 72 that penetrates through the front separating plate 11f is screwed into the screw hole at the center of the sliding piece 71 so as to adjust the tightness of the sliding piece 71 against the lock core.

The latch mechanism 3 is installed in the chassis 1 as shown in FIG. 6. The latch mechanism 3 comprises a lock latch 30 formed to penetrate through the latch hole 153, a latch mount 31 connected with the lock latch 30, a shaft rod 32 connected with the latch mount 31, and a linking mount 33 mounted at one end of the rod 32. As shown in FIG. 5, the lock latch 30 is a block having a curled and slanted surface at one end thereof. A pivoted piece 301 is disposed in the hole at the center of the lock latch 30. In addition, a pivot shaft 302 is affixed at the back end of the lock latch 30, and the pivot shaft 302 is sleeved by an elastic element 303 having a washer and a C-shaped fastening ring.

The latch mount 31 comprises a mounting plate 310 and a mounting frame 311 having wings at two sides thereof. Besides, two sides of the mounting plate 310 and two wings of the mounting frame 311 are locked together by fixing pillars 312, each having screw thread at one end thereof. The mounting plate 310 has a gap 314 that opens to the top and a protruding portion 315 is formed on the upper rim of one side of the mounting frame 311 adjacent to the substrate 310.

The lock latch 30 is connected to the latch mount by slotting the pivot shaft 32 into the gap 314 and bringing the washer 302 close to inner surface of the mounting plate 310. In addition, a fixing hole (not shown) is formed on the back end of the lock latch 30 corresponding to the position of the fixing pillar 312 exposed on the mounting plate 310 to ensure no rotation of the lock latch 30 with respect to the latch mount 31. By the aforementioned method, the latch 30 connected with the latch mount 31 may be pulled out with respect to the latch mount 31 by compressing the elastic element 303 on the pivot shaft 302. The lock latch 30 is then put back reversibly by rotating 180°, to accommodate the inward or outward opening of the door leafs.

The latch mount 31 may also be fabricated by integrating the mounting plate 310 and the mounting frame 311. Alternatively, the mounting plate 310 and the mounting frame 311 can be connected by soldering or fusing and the gap 314 is replaced by a shaft hole. Nevertheless, by direct punching and pressing of the mounting plate 310 and the mounting frame 311, the fabrication is simplified and the cost is reduced. The mounting plate 310 and the mounting frame 311 are connected by the fixing pillars 312. A fixing part of the fixing pillar 312 is also capable of affixing, while the use of gap 314 is beneficial for easy installation of the lock latch 30.

The front end of shaft rod 32 is screwed into the back wall of the frame 311 and through the corner board 126 between the cover and the substrate 12. There is also an elastic element 320 fitted between the side wall at the back of the frame 311 and the corner board 126 for providing an elastic recoil force. As shown in FIG. 5, a circular hole is formed at the center of the frame mount portion 330 of the linking mount 33for fitting the one end of the shaft rod 32. An elastic element 321 is also configured between the frame mount portion 330 and one end of the shaft rod 32 for buffering. The elastic element 321 is restrained by a C-shaped fastening ring at the one end of the shaft rod. The protruding pillar 331 at the upper and lower ends of the frame mount portion 330 are held against edges of the trench holes 127 in the cover and the substrate 12, respectively, for restricting the elastic element 321 and maintaining a distance between the frame mount portion 330 and the corner board 126. The linking mount 33 extends from one side of the frame mount portion 330 to form an extended portion 332. The upper front end of the extended portion 332 forms laterally a linking arm 334 toward the tongue mechanism 2. The linking arm 334 has a protruding portion 335, which protrudes backward. The upper and lower ends of the extended portion 332 have protruding portions 333 having a similar function as the protruding pillar 331 for sliding in the trench holes 128 in the cover and the substrate 12 to maintain the linear motion of the linking mount 33.

A security mechanism 4, as shown in FIG. 5 and FIG. 6, is installed in the chassis 1 on one side of the lock latch mechanism 3. The security mechanism 4 comprises a security latch element 40 formed to penetrate through the security latch hole 152, and a swing piece 41 pivoted in the chassis 1. As shown in FIG. 5, a free end of the swing piece 41 pivotally swings to the latch mount 31 to contact the latch mechanism 3, when the security element 40 is retracted in the security latch hole 152, so as to contact the security latch element 40 by obstructing the latch 30 from retracting into the latch hole 153.

Referring to both FIG. 4 and FIG. 5, the security latch element 40 comprises the security latch 401 at the front section thereof and the axial board 402 at the back section thereof. The front end of the axial board 402 is a linear portion. The linear portion penetrates the corner board 123 of the aforementioned elastic piece 24. Also, the elastic element 403 is configured between the security latch 401 and the corner board 123 for elastic recoiling. The back end of the axial board 402 forms a triangular portion with a front hook.

The swing piece 41 has a cylindrical piece 410 at one end thereof to sleeve the pivot shaft 129 on the substrate 12. The protruding pillar 411 at other end (free end) of the swing piece 41 contacts the triangularly slanted portion of the axial board 402. As shown in FIG. 6, a screw spring 412 is mounted on the shaft 129, with one end of the screw spring 412 hooks to the protruding portion 130 of the rear separating plate 11r, and the other end hooks to the gap portion 413 at one side of the swing piece 41, so as to provide the force to enforce the swing piece 41 to swing in counter-clockwise manner. The other side of the swing piece 41 close to the frame mount portion 330 of the linking mount 33 has a protruding portion 414 that protrudes toward the frame mount portion 330.

The doorknob linking mechanism 5, as shown in FIG. 6, is installed in the chassis 1. The doorknob linking mechanism 5 comprises a rotating element 50 pivoted in the chassis 1 and a linking element 52 pivoted on the rotating element 50.

As shown in FIG. 5, the main body of the rotating element 50 is a protruding shaft portion 500. The protruding shaft portion comprises a zigzag connection hole 501 at the center thereof, and a sectional difference is formed at the middle section of the outer rim thereof. The protruding shaft portion 500 has a protruding rim 502 with a larger shaft radius at the bottom of the protruding shaft portion. A gap 503 is formed at an arc section of the protruding rim 52. A recovering arm 504 extended outwardly from the protruding shaft portion 500 is formed on another protruding rim 502 approximately opposite to the gap 503. In addition, a protruding pillar 505 is formed on an arc section of the protruding rim 502 between the gap 502 and the recovering arm 504.

The diameter of the linking element 52 is approximately equal to the outer diameter of the aforementioned protruding rim 502, the linking element 52 has a hole 520 at the center thereof. The outer rim of the hole 520 comprises an arc trench hole 521. An axially extended linking arm 522 is formed close to one end of the arc trench hole 521. A gap 523 is formed on the linking gap 52 corresponding to the other end of the arc trench hole 521. The protruding shaft portion 500 of the rotating element 50 is sleeved by the hole 520 of the linking element 52 and stopped at the sectional difference but is pivoted with respect to the rotating element 50. The protruding pillar 505 of the rotating element 50 penetrates the arc trench hole 521 of the linking element 52 and is close to the end of the arc trench hole 521. In addition, due to the sectional difference, a space is formed between the linking element 52 and the protruding rim 502 of the rotating element 50.

After the rotating element 50 is sleeved with the linking element 52, the protruding shaft portion 500 of the rotating element 50 that protrudes from the linking element 52 is fitted in the shaft hole 131 on the substrate 12 or the corresponding shaft hole of the cover. The doorknob (not shown) outside the substrate 12 or the cover connects with the connection hole 501 of the protruding shaft portion 500 by a square connection shaft portion in the front thereof and is turned to cause rotation of the rotating element 50 with respect to the chassis 1. Two sets of symmetrically stacked rotating element 50 and linking element 52 are generally configured between the substrate 12 of the chassis 1 and the cover. As shown in FIG. 5, the doorknob connects with the protruding shaft portion 500 of the substrate 12 and the cover, respectively. The two rotating elements 50 are stacked by connecting with their bottoms in such a way that, a convex portion 506 is formed on a center portion of one bottom and a concave portion (not shown) is formed on the center portion of the another bottom. As a result, the rotating elements are tightly connected to linking structure therebetween to prevent the linking structure from falling off.

The doorknob linking mechanism 5 configured in the chassis 1 can be seen by referring to FIG. 6. The front end of the linking arm 522 of the linking element 52 inserts into the gap between the frame mount portion 330 of the linking mount 33 and the corner board 126. The recovering arm 504 of the rotating element 50 then connects with a recovering mechanism 53. The recovering mechanism 53 provides a recovering force to relocate the rotating element 50 to its original position, after the doorknob is turned to cause rotation of the rotating element 50 and the doorknob is released. The recovering mechanism 53 includes a shaft rod 530 that is formed to penetrate through a portion of the side separating plate 11b close to the back separating plate 11r, has one end restrained by a C-type ring, and the other end affixed with an obstruction board 531. A separating plate 532 is formed and penetrated through with the rod 530, and an elastic element 533 is sleeved around the rod 530 between the separator 532 and the side separating board 11b. The front end of the recovering arm 504 inserts into the gap between the obstruction board 531 and the separating plate 532. When the rotating element 50 is rotated, the recovering arm 504 shifts the separator 532 and the elastic element 533 is compressed to acquire the recovering force for reverse rotation.

The doorknob control mechanism 6, as shown in FIG. 6, is installed within the chassis 1. The doorknob control mechanism 6 comprises a restricting element 61 that restricts the relative movements between the linking element 52 and the rotating element 50, a button that is pivoted in the chassis 1, and a pair of transmission pieces 63 that contacts the button 62. The restriction of the restriction element 61 on the linking element 52 is released by the transmission piece 63 via pressing the button 62.

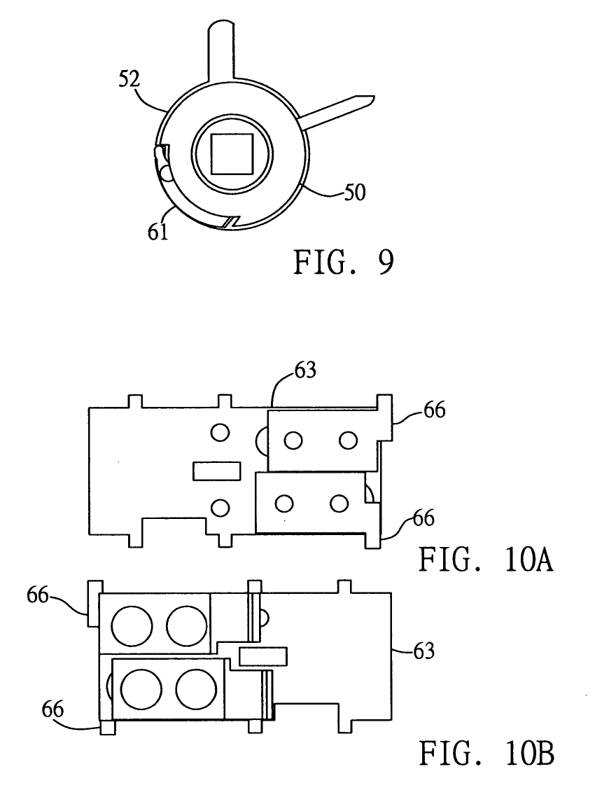

Again, referring to FIG. 5, the restriction element 61 is an arc plate with one end having a narrow handle 610 and the other end having a buckling paw 611 bent at a right angle. A passive portion that contacts the rotation element 50 is thus formed. Also, a shaft 612 is pivoted on the linking element 52 near the gap 523 in the space between the protruding rim 502 of the linking element 52 and rotating element 50,. As shown in FIG. 9, the top portion of the shaft 612 forms a flat shape to prevent the restriction element 61 from falling off. The restriction element 61 is disposed between the linking element 52 and the rotating element 50, as shown in FIG. 8. The narrow handle 610 and the gap 523 are in the same position, while the buckling pawn 611 is buckled at one end of the arc gap 503 of the rotating element 50. The bottom of the shaft 612 is sleeved with a curled spring (not shown), such that one end is hooked at the circular hole of the linking element 52, and the other end is hooked at the circular hole of the restricting element 61. When the narrow handle 610 is pushed and pressed from the gap 523 by an external force, the restriction element 61 rotates and the buckling pawn 611 leaves one end of the arc gap 503. When the external force is removed, the curled spring provides the recovering force for the restriction element 61 to move back to its original position.

The button 62 comprises a cylindrical portion 621 and two wings 622a and 622b protruding from one side of the cylindrical portion 621. The cylindrical portion 621 is also disposed around a structure pillar 132 on the substrate 12. The structure pillar 132 is the same as the other structure pillars 133, 134, 135 distributed around the substrate 12. The center of the structure pillar 132 has a screw hole for screwing and fixing the structure pillars when the substrate 12 is covered with the cover (not shown). As shown in FIG. 6 to FIG. 8, the inner surface of two wings 622a and 622b on the button 62, which rotates with respect to the structure pillar 132, contacts with the two transmission pieces 63 vertically formed to slide between the substrate 12 of the chassis 1 and of the cover. The outer portions of two wings 622a and 622b are then exposed in the button hole 154 for pressing.

Two transmission pieces 63 are similar to the plates as shown in FIG. 5, the protruding portion 630 from rims of the upper and lower plates slides in the trench hole 136 of the substrate 12 and the corresponding trench hole of the cover. The two transmission pieces 63 also link with a lever piece 64 pivoted to the shaft pillar 137. Two ends of the lever piece 64 penetrate through the trench holes 632 at the center of the two transmission pieces 63, respectively. The sharp end of the lever piece 64 close to the side separator 11b contacts with a reed 65 affixed to the side separating plate 11b. When one wing 622a of the button 62 is pressed, the wing 622a shifts a transmission piece 63 to move forwards, so that one end of the lever piece 64 is pushed by the transmission piece 63 to rotate the lever piece 64. The other end of the lever piece 64 close to the side separating plate 11b then pushes another transmission piece 63 to move backward. Meanwhile, the sharp end close to the side separating plate 11b and overpasses the sharp end of the reed 65 to provide the feeling of the push button 62 to reach its desired position. When the other wing 622b of the button 62 is pushed, all components move in exactly the same manner but in reverse order.

As shown in FIG. 6, the transmission piece 63 that is away from the side separating plate 11b is directly facing the doorknob linking mechanism 5 mounted in the chassis 1. An adjustment piece 66 that may be push in and out is mounted in the transmission piece 63 near one end of the doorknob linking mechanism 5. In order to accommodate the requirement of bi-directional installation, as shown in FIG. 10A and FIG. 10B, there are two adjustment pieces 66 formed to slide on one side of the transmission piece 63 by penetrating through two sliding trenches 633 on one end of the transmission piece with two shaft pillars 67. Then the two shaft pillar 67 forms a flat top portion and the two elastic pieces 68 are affixed on the other side of the transmission piece 63. The non-affixed end of the two elastic pieces 68 forms a bow shape 681 that makes a linear contact with the other side of the transmission piece 63. When the transmission piece 63 pushes out the adjustment piece 66 and the elastic piece 68 moves together with the adjustment piece 66, the bow shape 681 overpasses a projection dot 634 formed on the other side of the transmission piece 63 to provide the feeling that the adjustment piece 66 is pushed in or out.

When the adjustment piece 66 is pushed out with respect to the transmission piece, the adjustment piece 66 is directly facing the gap 523 of the linking member 52 and the narrow handle 610 of the restriction member 61. When the wing 622 that is away from the side separating plate 11b of the button 62 is pressed, the protruding portion 662 at the front end of the adjustment piece 66 then further pushes the narrow handle 610. The restriction member 61 is thus rotated and the buckling pawn 611 leaves the arc-shaped gap 503 to release the restriction of the restriction member 61 on rotation of the linking member 52 and the rotating member 50 together. When the doorknob is turned from outside of the door, the rotating member 50 is rotated without linking the lock latch to open the door.

As the lock may be installed on either the left or the right side of a door leaf, one may properly push out an adjustment piece 66 and push in another adjustment piece 66, so that the wing 622a of the button 62 is pressed, causing an unlinked rotation when the doorknob outside of the door is turned.

In addition, in the aforementioned tongue mechanism 2, a sliding mount 21 slides in the concave portion 635 between the sliding pillar 212 on the surface of the substrate 12 and at the bottom of the transmission piece 63 where the adjustment piece 66 is disposed. When turning the actuator rod 70 in a counterclockwise direction by using a key to open the lock, the actuator rod 70 pushes the driving member 22 to rotate and drives the sliding mount 21 to slide. The lock tongue 20 extends from the lock tongue hole 151. As one end of the linking board 79 that contacts with the sliding pillar 212 is pushed by the sliding pillar 212, the linking board 79 rotates in a counterclockwise direction. The other end of the linking board 79 that contacts with the concave portion 635 pushes the transmission 63 to move to the right (equivalent to pressing the wing 622a of the button 62). As a result, the restriction of the restriction member 61 on rotation of the linking member 52 and the rotating member 50 is released so as to make an unlinked rotation of the doorknob outside of the door.

Further, a fireproof piece 74 is disposed over the upper rim of the frame 311 of the lock latch mount 31. A guiding trench 742 having an elongated oval shape is formed on one side of the fireproof piece 74 to be penetrated by the protruding portion 315 at the side wall upper rim of the latch mount 31. The fireproof piece 74 may cover by sliding up and down over the latch mount 31. As shown in FIG. 6, the fireproof piece 74 is located at the inner side of a frame wall where a security pin 741 is installed and inserted into the frame board 311. The fireproof piece 74 is prevented from falling down due to gravity by means of the frame wall of the frame board 311. The security pin 741 is composed of hot molten material. Therefore, when a fire accident occurs, the security pin 741 is melted by the heat of the fire such that the fireproof piece 741 will fall down to the position of the dotted line as shown in FIG. 6. In this case, when one wishes to retract the lock latch 30 into the latch hole 153 using a key or by turning the doorknob, the fireproof piece 74 that is moving to the right together with the lock latch mount 31 will be blocked by the erect pillar 139 of the substrate 12. The lock latch 30 may not retract further into the latch hole 153. So, the door leaf may thus remain closed and the fire may be blocked.

The operation of the door lock of the present invention is described in detail in the following.

If the door lock of the present invention is installed at the right side of a door (the door hinge is at the left and the door lock is at the right if looking from inside of the door), the substrate 12 of the door lock as shown in FIG. 4 is closer to the inside of the door. Therefore, the adjustment piece 66 on the transmission piece 63 of the latch mechanism may be adjusted to the status as shown in FIG. 10A by using a finger or a screwdriver. Referring to FIG. 7, only the adjustment piece 66 away from the substrate 12 is pushed out when the wing 622a of the button 62 is pressed, so only the restriction element 61 pivoted on the linking element 52 away from the substrate 12 may be pushed by the adjustment piece 66. The restriction on the linking element 52 is thus released such that the linking element 52 may not rotate synchronously with the rotating element 50. Meanwhile, the doorknob outside of the door can only make unlinked rotation while the doorknob inside of the door may still link the linking mount 33 of the latch mechanism 3 to retract the lock latch 30 into the latch hole 153. Thus, one may be stopped from entering via the door outside the house but allowed to go out via the door inside the house. When the wing 622b of the button 62 is pressed, both the doorknobs inside and outside of the door may be turned to make the lock latch 30 retracting into the latch hole 153.

Similarly, if the door lock of the present invention is installed at the left of a door, since the substrate becomes closer to outside of the door, the adjustment piece 66 shown in the upper portion of FIG. 10A must be pushed in and the adjustment piece 66 must be pushed out to cause an unlinked rotation of the doorknob outside of the door when the wing 622a of the button 62 is pressed.

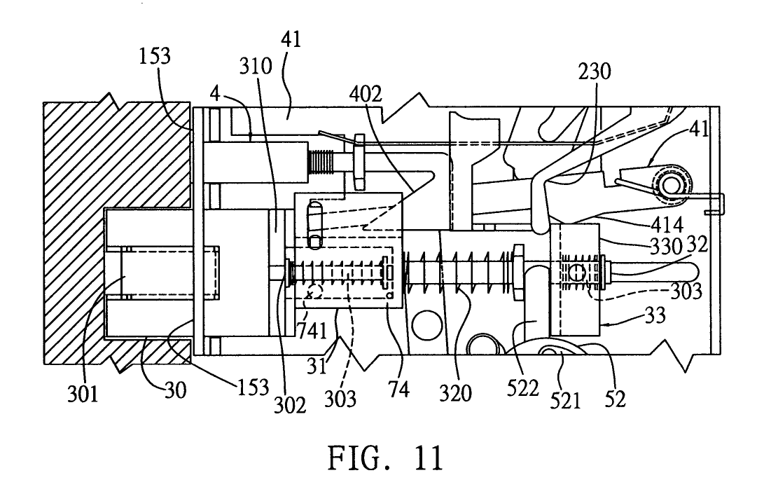

When the door leaf is closed, the lock latch 30 then inserts the corresponding latch hole on the doorframe but the doorframe does not have a latch hole for the security latch 401 of the security mechanism 4 to enter. Therefore, the swing piece 41 contacts with triangularly slanted side of the shaft board 402 by the protruding pillar 411 on its free end, as originally shown in FIG. 6. Since the shaft board 402 moves backward, the swing piece 41 then swings down due to action of the screw spring 412 and removal of obstruction from the shaft board 402, the free end of the swing piece 41 thus leans on the frame board 311, as shown in FIG. 11. In this manner, since the latch mount 31 moves backward, the free end of the swing piece 41 holds the ear portion of the frame board 311, so the lock latch can not be pressed into the chassis 1 from the crack between the door and the frame by a tool. Conversely, by means of a linking mount 33, the frame portion 330 of the linking mount 33 pushes the swing piece 41 to swing up along the protruding portion 414 of the swing piece 41, so the latch mount 31 smoothly links the lock latch 30 to retract into the chassis 1.

After the door leaf is closed, the doorknob control mechanism 6 causes the unlinked rotation of the doorknob, and the safety latch mechanism 4 ensures that the lock latch 30 is not pressed into the chassis from the door gap using a tool. In addition, the lock core is opened by the key to rotate the actuator rod 70 pivoted to the lock core, which in turns drive the driving element to rotate and link the lock tongue 20 via the sliding mount 21 to enter the corresponding latch hole on the doorframe. As shown in FIG. 7, this further reduces the possibility of stranger trespassing. If the wing 622a of the button 62 is not pressed down to make unlinked rotation of the doorknob outside of the door, the wing 662a of the button 62 may be linked and pressed down as the tongue 20 enters the latch hole using the key, according to the arrangement where the linking board 79 is disposed in between the sliding mount 21 and the transmission pieces 63 mounted with the adjustment pieces 66.

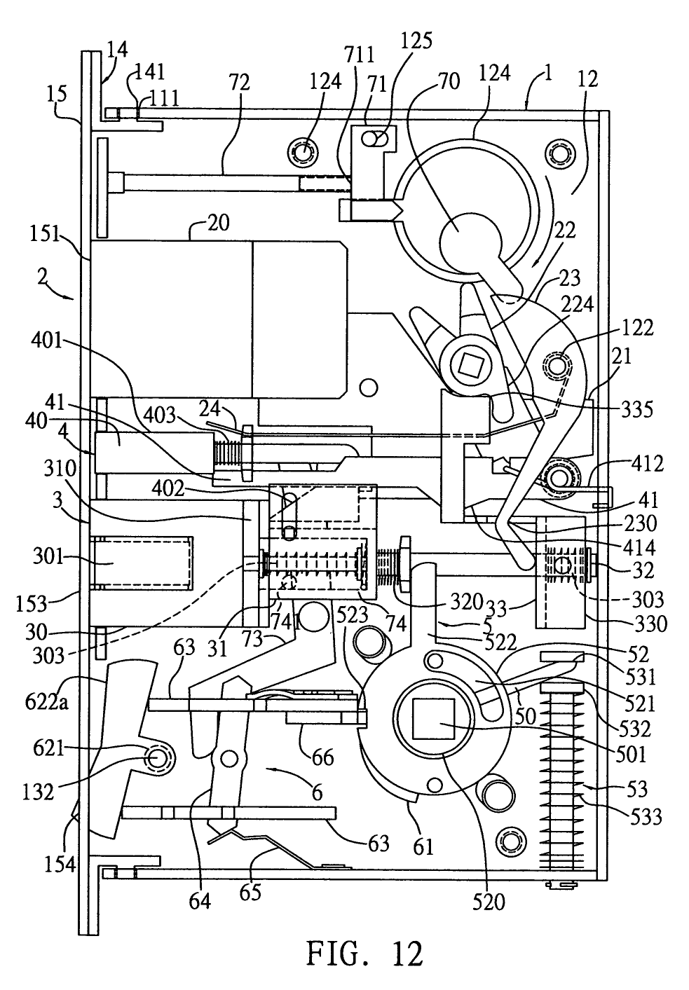

According to the door lock of the present invention, the locked door leaf may be opened by turning the doorknob from inside or by using a key from outside. When the door is opened by turning the doorknob from inside, the lock latch 30 retracts into the chassis 1 as described above. As shown in FIG. 8, since the protruding portion 335 protruding backward of the linking arm portion 334 contacts the sliding portion 224 of the driving element 22, the driving member 22 will be pushed in a counterclockwise direction when the linking mount 33 is pushed backward, the tongue 20 is thus retracted into the chassis 1. When the door is opened by turning the key in a complete round, the actuator rod 70 pushes the driving member 22 to rotate, and the sliding mount 21 links the lock tongue 20 to retract into the chassis 1. Then, the actuator rod 70 leans on one side of the linking frame 23, while the front end of the linking arm 230 on the other side of the linking frame 23 contacts with the frame mount portion 330 of the linking mount 33. Thus, when the key is turned to the second round, as shown in FIG. 12, the actuator rod 70 then pushes the linking frame 23 to rotate and pushes the linking mount 33 to move backward by the linking arm 230 of the linking frame 23. The swing piece 41 swings upward and links the lock latch 30 to retract into the chassis 1 to complete opening of the door lock of the present invention.

Therefore, the improvements of the present invention may be summarized into the following:

(1) The door lock of the present invention comprises a doorknob linking mechanism 5 that links the rotating member 50 pivoted to the chassis and the linking member 52 pivoted to the rotating member 50, and a doorknob control mechanism 6 that pushes a pair of transmission pieces 63 formed erectly to slide between the substrate 12 of the chassis 1 and the cover by the button 62 pivoted to the chassis 1 to release the restriction of the restriction member 61 on synchronous movement of the linking member 52 and the rotating member 50. The door lock of the present invention has a simplified linking architecture and the components disposed in parallel between the substrate 12 of the chassis and the cover are all connected by pivoting (the protruding portion 500 is disposed around the hole 520 and the protruding portion 506 matches the concave portion) to tighten the linking structure therebetween and to avoid linking structure from falling off. Therefore, the malfunction rate of the present invention is very low.

(2) The door lock of the present invention is an improved structure of the doorknob linking mechanism 5 and the doorknob control mechanism 6. The linking architecture is very simple with a clear spatial arrangement as most connection between the elements is achieved by encasing and pivoting. The use of elastic members is minimized to enhance the construction reliability. Besides, since the spatial arrangement is simple and a design of elastic piece 68 and protrusion dot 634 is employed, the adjustment piece 66 of the doorknob mechanism 6 may be pushed by a finger or a screwdriver without dismantling any element. Thus, the present invention saves a lot of installation time.

(3) The fireproof piece of the door lock of the present invention makes a subtle use of the gravity and the relative position between the latch mount 31 and the erect pillar 139 to prevent the door from opening in case of a fire accident.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is

1. A door lock structure, comprising:
a chassis;
a tongue mechanism comprising a lock tongue penetrating the chassis, a slide mount connected to the lock tongue, and a driving member having one end connected to the slide mount;
a latch mechanism comprising a lock latch penetrating the chassis, a latch mount connected to the lock latch, a shaft rod connected to the latch mount, and a linking mount mounted on one end of the shaft rod;
a security latch mechanism comprising a security latch penetrating the chassis, and a swing piece having a free end that swings to contact the latch mount of the latch mechanism for stopping the lock latch from retracting into the chassis when the security latch retracts into the chassis;
a doorknob linking mechanism comprising at least one rotating member pivoted to the chassis and connected to at least one external doorknob, and at least one linking member pivoted to the rotating member, wherein the linking member has an arm contacting the linking mount of the latch mechanism; and
a doorknob control mechanism comprising at least one restriction member that restricts relative motion between the linking member and the rotating member of the doorknob linking mechanism, a button, and a pair of transmission pieces contacting the button, wherein the button is pushed to allow one of the transmission pieces to release restriction from the restriction member on the linking member;
wherein the restriction member is pivoted to the linking member and has a first end forming a passive portion that contacts the rotating member, and the pair of transmission pieces each has a first end contacting the button, with a second end of the one of transmission pieces being adjacent to a second end of the restriction member, making this transmission piece slide between two corresponding walls of the chassis and linked with a lever piece pivoted to the chassis.

2. The door lock structure as recited in claim 1, wherein the at least one rotating member, linking member and restriction member are respectively provided as two in number symmetrically arranged in the chassis, and the at least one doorknob is also provided as two in number respectively disposed on two sides of the chassis and pivoted to the two rotating members.

3. The door lock structure as recited in claim 1, wherein the button comprises two wings each having an inner surface contacting the first end of each of the transmission pieces.

4. The door lock structure as recited in claim 3, wherein the one of transmission pieces is shifted by the corresponding wing of the button to push the second end of the restriction member, so as to rotate the restriction member and release the passive portion of the restriction member from the rotating member.

5. The door lock structure as recited in claim 1, wherein the lock latch is flexibly pulled out from the latch mount, and rotated by 180 degrees to be restored back into the latch mount in a reverse direction.

6. The door lock structure as recited in claim 1, wherein the chassis comprises a frame and a lid for covering the frame, the frame having a substrate and separating plates peripherally formed on the substrate, and two ear-shaped members are installed in gaps between the separating plates to affix the chassis on a door board.

7. The door lock structure as recited in claim 1, further comprising a lock core having the driving member, allowing the lock tongue to exert a force on the other end of the driving member to urge the slide mount to project out from or retract into the chassis.

8. The door lock structure as recited in claim 1, wherein the latch mechanism further comprises a fireproof piece formed on the latch mount, with a guiding trench formed along one side of the fireproof piece, to allow a protruding portion on a side wall of the latch mount to project into the guiding trench, such that the fireproof piece moves up and down to cover a security pin in the latch mount to prevent the fireproof piece from falling.

9. The door lock structure as recited in claim 8, wherein the security pin is melted at a high temperature during a fire to allow falling of the fireproof piece under gravity, and the fireproof piece is obstructed between the latch mount and a shaft pillar fixed on the chassis to prevent the fireproof piece from entering a latch hole when the lock latch is urged to retract into the chassis, such that the door lock structure remains locked during the fire.

10. The door lock structure as recited in claim 1, further comprising an adjustment piece formed on the second end of the one of transmission pieces for use to release the restriction from the restriction member on the linking member.
